(19) United States
(12) Patent Application Publication
(10) Pub. No.: US 2025/0298874 A1
(43) Pub. Date: Sep. 25, 2025

(54) Adaptive Intelligent User Validation System based on Behavioral Activities and Biometric Indicators

(71) Applicant: TEACHERS INSURANCE AND ANNUITY ASSOCIATION OF AMERICA, New York, NY (US)

(72) Inventors: Upendra Mardikar, Fremont, CA (US); Rares Ioan Almasan, Paradise Valley, AZ (US); Joel Amick, Huntersville, NC (US); Rajiv Dulepet, West Hills, CA (US); Cory Hefner, Charlotte, NC (US)

(21) Appl. No.: 18/610,592

(22) Filed: Mar. 20, 2024

(51) Int. Cl. G06F 21/31; G06F 21/32

(52) U.S. Cl. CPC G06F 21/316; G06F 21/32

(57) ABSTRACT

Systems and methods for adaptive intelligent user validation are provided. Example techniques may include receiving an indication of initial user input associated with a user account for an online service during an authorized user session; providing the initial user input to a machine learning model as training data; generating a user signature associated with the user account based on providing the initial user input to a machine learning model as training data; receiving subsequent input associated with a subsequent attempt to access the online service by the user account; comparing the subsequent input to the user signature associated with the user account; and allowing a subsequent authorized user session of the online service for the user account based on determining that the subsequent input matches the user signature associated with the user account.

### FIELD OF THE INVENTION

The present disclosure generally relates to technologies associated with cybersecurity, and more particularly, to technologies for ongoing user validation during navigation and use across multiple channels while balancing user risk and access convenience.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Cybersecurity has generated heightened interest in recent years. Validating a user as the intended subject is critical as cyber threats and techniques become increasingly sophisticated and elaborate. Data security remains a significant concern, especially during the transmission of sensitive information between users and businesses they seek to interact with. Existing measures are becoming less efficient, inconvenient for the user and less trustworthy. There is a need for a more user-friendly experience that is still capable of safeguarding data.

### SUMMARY

In one aspect, a computer-implemented method for adaptive intelligent user validation is provided. The method may include receiving, by one or more processors, an indication of initial user input associated with a user account for an online service during an authorized user session; providing, by the one or more processors, the initial user input associated with the user account for the online service during the authorized user session to a machine learning model as training data; generating, by the one or more processors, based on providing the initial user input associated with the user account for the online service during the authorized user session to the machine learning model as training data, a user signature associated with the user account; receiving, by the one or more processors, subsequent input associated with a subsequent attempt to access the online service by the user account; comparing, by the one or more processors, the subsequent input associated with the subsequent attempt to access the online service by the user account to the user signature associated with the user account; and allowing, by the one or more processors, a subsequent authorized user session of the online service for the user account based on determining that the subsequent input associated with the subsequent attempt to access the online service by the user account matches the user signature associated with the user account. The method may include additional, less, or alternate actions, including those discussed elsewhere herein.

In another aspect, a computer-implemented method for adaptive intelligent user validation is provided. The method may include receiving, by one or more processors, an indication of initial user input associated with a user account for an online service during an authorized user session; providing, by the one or more processors, the initial user input associated with the user account for the online service during the authorized user session to a machine learning model as training data; generating, by the one or more processors, based on providing the initial user input associated with the user account for the online service during the authorized user session to the machine learning model as training data, a user signature associated with the user account; receiving, by the one or more processors, subsequent input associated with a subsequent attempt to access the online service by the user account; comparing, by the one or more processors, the subsequent input associated with the subsequent attempt to access the online service by the user account to the user signature associated with the user account; and initiating, by the one or more processors, an out of band authentication based on determining that the subsequent input associated with the subsequent attempt to access the online service by the user account does not match the user signature associated with the user account. The method may include additional, less, or alternate actions, including those discussed elsewhere herein.

In still another aspect, a computer system for adaptive intelligent user validation is provided. The computer system may include one or more processors and a memory storing computer-executable instructions that, when executed by the one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and allow a subsequent authorized user session of the online service for the user account based on determining that the subsequent input associated with the subsequent attempt to access the online service by the user account matches the user signature associated with the user account. The system may include additional, less, or alternate functionality, including that discussed elsewhere herein.

In yet another aspect, a computer system for adaptive intelligent user validation is provided. The computer system may include one or more processors and a memory storing computer-executable instructions that, when executed by the one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and initiate an out of band authentication based on determining that the subsequent input associated with the subsequent attempt to access the online service by the user account does not match the user signature associated with the user account. The system may include additional, less, or alternate functionality, including that discussed elsewhere herein.

In still another aspect, a non-transitory computer-readable storage medium storing computer-readable instructions for adaptive intelligent user validation is provided. The computer-readable instructions, when executed by one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and allow a subsequent authorized user session of the online service for the user account based on determining that the subsequent input associated with the subsequent attempt to access the online service by the user account matches the user signature associated with the user account. The instructions may direct additional, less, or alternative functionality, including that discussed elsewhere herein.

Additionally, in another aspect, a non-transitory computer-readable storage medium storing computer-readable instructions for adaptive intelligent user validation is provided. The computer-readable instructions, when executed by one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and initiate an out of band authentication based on determining that the subsequent input associated with the subsequent attempt to access the online service by the user account does not match the user signature associated with the user account. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary schematic diagram for adaptive intelligent user validation, according to some embodiments;

FIG. 2 depicts an exemplary computer system for adaptive intelligent user validation, according to some embodiments; and

FIG. 3 depicts a flow diagram of an exemplary computer-implemented method for adaptive intelligent user validation, according to some embodiments.

While the systems and methods disclosed herein are susceptible of being embodied in many different forms, they are shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The present disclosure provides a novel artificial intelligence (AI)-based method to create and utilize user signatures by channel of engagement based on implicit and explicit behavioral and biometrics key indicators. In addition, these signatures may be dynamically adjusted based on new authentication and session data. The adaptive intelligent user validation system provided herein may be based on behavioral activities and biometric indicators. The system provides a comprehensive solution to the security challenges of correctly identifying the intended user while simultaneously identifying imposter attempts to access assets within a given user's session. The techniques provided herein may incorporate generative AI, behavioral analytics, and/or biometric data captured as a baseline of comparison to actual activity presented to ensure the confidentiality, integrity, and authenticity of the user during interaction and navigation. In an example, after creating a user account and having a channel signature created, a guest may sign on as an existing user, and may try to perform a high-risk activity. The user's session signature for that engagement channel may be compared to the existing channel signature and found to be a match. In this example, because the user is validated, they can continue navigation without inconvenience.

The adaptive intelligent user validation system provided herein addresses the critical need for enhanced data security in user validation and provides for a better user experience. Moreover, the system offers a comprehensive solution to protect data, reducing the risk of data breaches and unauthorized access. In addition, the system may enhance the user experience by reducing friction needed for risky transactions and activities by re-validating users in the background instead of forcing a new authentication event.

### Example Schematic Diagram

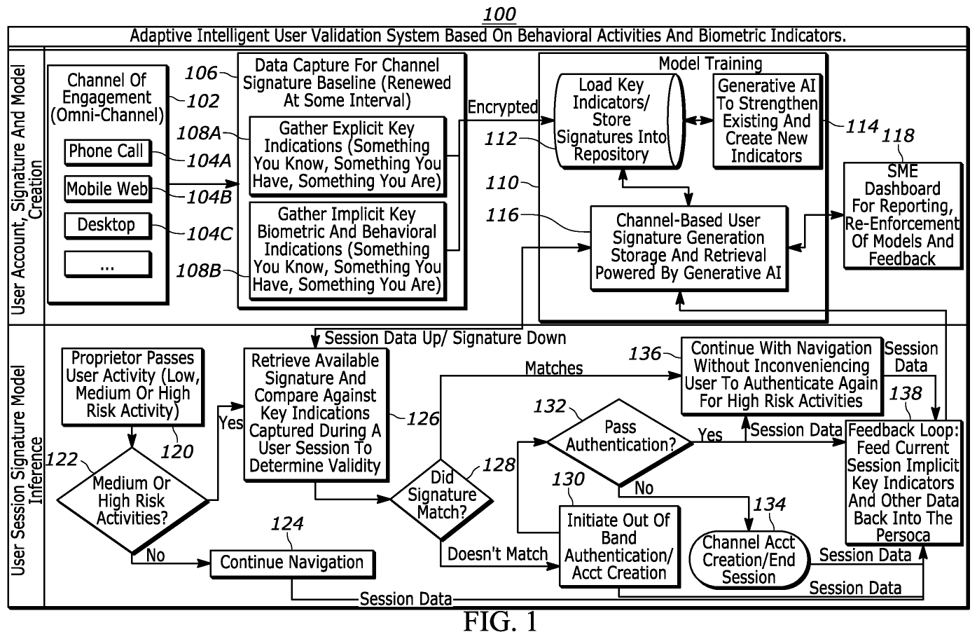

Referring now to the drawings, FIG. 1 depicts an exemplary schematic diagram 100 for adaptive intelligent user validation, according to one embodiment.

Generally, the adaptive intelligent user validation system provided herein may include a baseline identification of behavior. As shown in FIG. 1, a user may access an online service from one of many possible channels of engagement 102. For instance, a user may access the online service via a phone call 104A, a mobile web application 104B, a desktop 104C, etc. During the user's session as the user uses the online service, data may be captured 106. This data may include explicit key indicators 108A for each user, which may include questions/fields for which a user provides input, and/or implicit key biometric and behavioral indicators 108B for each user, which may include data associated with the way the user interacts with the online service during their session. That is, using biometric and behavior-based data, a baseline signature may be developed for each engagement channel that can be associated to a given user. Each user may have a unique signature for each engagement channel.

A model 110 (e.g., an AI and/or machine learning model) may be trained using the explicit key indicators 108A and/or the implicit key indicators 108B. The model 110 may load the key indicators and/or signatures associated therewith into a repository 112. A generative AI model 114 may analyze the key indicators and/or signatures from the repository 112 and may strengthen the existing key indicators and generate new indicators for respective users based on the existing key indicators for the respective users, and may use the key indicators from the repository 112 to generate (116) a channel-based user signature for each user.

Additionally, a subject matter expert (SME) dashboard 118 may report the generated signatures for each user so that the signatures may be reviewed, analyzed, and/or modified by subject matter experts. That is, the adaptive intelligent user validation system provided herein may include an intelligent alert system/dashboard (single pane of glass). The system may correlate data and information for use by a proprietor to monitor output and decisions, and provide it via the dashboard. In some examples, the system may include multiple Intelligent dashboards and alerting systems, and may provide the ability to customize intelligent dashboards to users' liking.

Furthermore, the adaptive intelligent user validation system provided herein may include a validation mechanism. That is, a robust validation process may be implemented to verify the identity of the intended user to reduce the likelihood of fraudulent activity, preventing loss of data or assets by nefarious means. For example, after the model 110 is trained and the various user signatures are generated, new user activities in attempting to access the online service may be analyzed to determine (122) whether each new user activity is a high risk activity, a medium risk activity, or a low risk activity. If a user activity is not a medium activity or a high risk activity, navigation may proceed (124).

If a user activity is a medium activity or a high risk activity, a user signature may be retrieved from the model 110 and compared (126) to the key indicators associated with the user activity to determine (128) whether the key indicators associated with the user activity match the user signature. If the key indicators match the user signature, the user's navigation within the online service may proceed (136) without authentication.

If the key indicators do not match the user signature, an out of band authentication (130) may be initiated. A determination 132 may be made as to whether the user passes the out of band authentication or not. If the user passes (132) the out of band authentication, the user's navigation within the online service may proceed (136). If the user does not pass the out of band authentication, the user may be prompted (134) to create an account, or the user's session may be ended.

Furthermore, the adaptive intelligent user validation system provided herein may include logging and auditing. The system may maintain detailed logs of all interactions, allowing forensic analysis and monitoring of potential security incidents. The adaptive intelligent user validation system provided herein may use the respective channel signature to generate a better user experience based on information gathered from key indicators, reducing the need for raising additional validation for various levels of risk activities.

For example, the data from the logs may be added to a feedback loop 138, in which the system updates the channel signature baseline as new activities evolve. The feedback look 138 may in some cases be used to further train the model 110, i.e., based on which key indicators are associated with successful authentications and/or unsuccessful authentications. For example, a feedback loop based on successful negotiation of an out-of-band authentication request may use the channel signature information gathered during a given session and the successful passing of a secondary authentication to update the channel signature to enable the user's signature to be updated based on the user's lifecycle changes.

### Example System

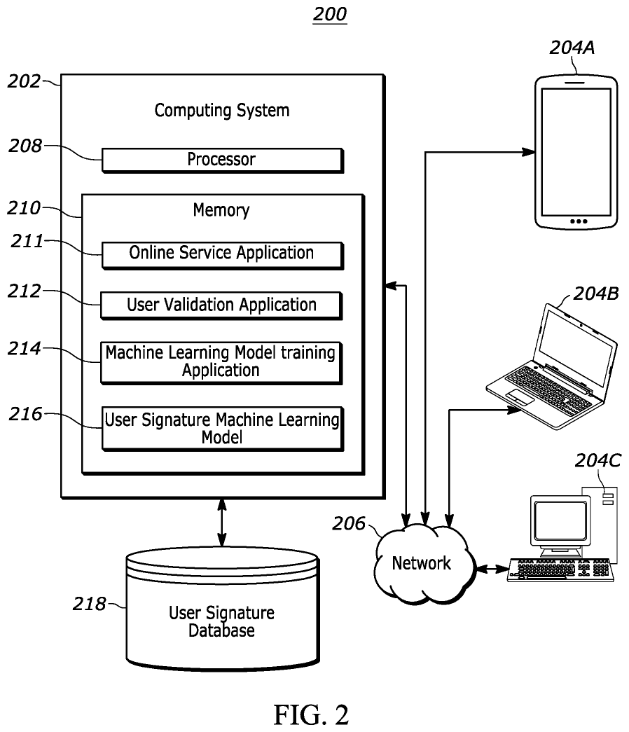

Referring now to the drawings, FIG. 2 depicts an exemplary computer system 200 for adaptive intelligent user validation, according to one embodiment. The high-level architecture illustrated in FIG. 2 may include both hardware and software applications, as well as various data communications channels for communicating data between the various hardware and software components, as is described below.

The system 200 may include a computing system 202, as well as, in some cases, one or more user computing devices 204A, 204B, 204C, etc., which may include, e.g., smart phones, smart watches or fitness tracker devices, tablets, laptops, virtual reality headsets, smart or augmented reality glasses, wearables, etc. The computing system 202, and user computing device(s) 204A, 204B, 204C, etc., may be configured to communicate with one another via a wired or wireless computer network 206.

Although one computing system 202, three user computing devices 204A, 204B, 204C, and one network 206 are shown in FIG. 2, any number of such computing systems 202, user devices 204, and networks 206 may be included in various embodiments. To facilitate such communications the computing system 202 and user computing devices 204A, 204B, 204C may each respectively comprise a wireless transceiver to receive and transmit wireless communications.

The user computing device(s) 204A, 204B, 204C may each include, or may be configured to communicate with, a user interface, which may receive input from users and may provide audible or visible output to users. Furthermore, the user computing devices 204A, 204B, 204C may include, or may be configured to communicate with, one or more respective sensors (including accelerometers, gyroscopes, and/or other motion sensors, in some examples). Additionally, the user computing device(s) 204A, 204B, 204C may each include one or more processor(s), as well as one or more computer memories. The memories of the user computing device(s) 204A, 204B, 204C may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) of the user computing device(s) 204A, 204B, 204C may store an operating system (OS) (e.g., iOS, Microsoft Windows, Linux, UNIX, etc.) capable of facilitating the functionalities, apps, methods, or other software as discussed herein. The memorie(s) of the user computing device(s) 204A, 204B, 204C may also store a web browser via which an online service may be accessed, a specialized software application for accessing the online service, and/or a software application for logging user actions as users access an online service via a web browser or specialized software application and sending indications of the logged user actions to the computing system 202.

The computing system 202 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 208 (e.g., CPUs) as well as one or more computer memories 210.

Memories 210 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 122 may store an operating system (OS) (e.g., Microsoft Windows, Linux, UNIX, etc.) capable of facilitating the functionalities, apps, methods, or other software as discussed herein. Memorie(s) 210 may also store an online service application 211, a user validation application 212, a machine learning model training application 214, and/or a user signature machine learning model 216.

Additionally, or alternatively, the memorie(s) 210 may store user data from various sources. For instance, the user data may be provided to the computing systems 202 by the user computing devices 204A, 204B, 204C, etc. For instance, the user data may include data provided by users as inputs (e.g., via respective user interfaces of the user computing devices 204A, 204B, 204C), as well as data captured by sensors of the user computing devices 204A, 204B, 204C, etc., and/or data captured by the computing system 202 as the users of the user computing devices 204A, 204B, 204C, etc., access the online service application 211. The user data may also be stored in a user signature database 218, which may be accessible or otherwise communicatively coupled to the computing system 202. In some embodiments, the user data or other data from various sources may be stored on one or more blockchains or distributed ledgers.

Executing the online service application 211 may include providing an online service (such as a banking service, an investment service, etc.) accessible by the various user devices 204A, 204B, 204C, etc. For instance, the online service application 211 may receive user inputs, data, etc., sent to the computing system 202 by the various user devices 204A, 204B, 204C, etc. (e.g., via respective applications executing on the various user devices 204A, 204B, 204C, etc., and/or via web browser applications executing on the various user devices 204A, 204B, 204C, etc.), may take various actions based on the user inputs, data, etc. Furthermore, the online service application 211 may send data to the respective user devices 204A, 204B, 204C. In particular, the online service application 211 may manage accounts associated with particular users, including sensitive and/or otherwise private data associated with particular users.

The online service application 211 may include various portions, areas, sections, etc., some of which are more secure portions, areas, sections, etc., associated with more private and/or sensitive user data and others of which are associated with less private, less sensitive, and/or more generally available data. For example, the private and/or sensitive user data may include financial data such as amounts of user money in various banking and/or investment accounts, user banking or credit account numbers, and/or user financial history, as well as user identifying data such as user contact information (e.g., phone numbers, addresses, etc.), user social security numbers, user passport or drivers' license numbers. Accessing the more secure portions, areas, sections, etc., of the online service using credentials for a particular user account may allow a user to view the private and/or sensitive user data associated with that account via the various user devices 204A, 204B, 204C, etc., and furthermore, may allow a user to modify the private and/or sensitive user data associated with that account via the various user devices 204A, 204B, 204C, etc., or make various other account selections, decisions, or inputs, such as input to proceed with a transaction or transfer, make an investment, etc. Accessing the less secure and/or less private, portions, areas, sections, etc., may allow a user to view, for instance, contact information for a customer support specialist associated with the online service, open or available hours associated with the online service. Furthermore, in some examples, accessing the less secure and/or less private portions, areas, sections, etc., may allow a user to view account data without modifying or updating the data, and/or without making any selections associated with the account data.

Executing the user validation application 212 may include validating the identities of users who attempt to access private and/or secure portions of the online service application 211 via their respective user devices 204A, 204B, 204C, etc. For instance, the user validation application 212 may analyze the user data stored on the memory 210 and/or the database 218 (e.g., data provided by users as inputs, as well as data captured by sensors of the user computing devices 204A, 204B, 204C, etc., and/or data captured by the computing system 202 as the users of the user computing devices 204A, 204B, 204C, etc., access the online service application 211). In particular, the user validation application 212 may generate user signatures for respective users based on previous and/or historical user data associated with respective users, and may compare user data captured during new attempts to access private and/or secure portions of the online service application 211 to the user signatures in order to validate the identities of respective users. Furthermore, in some examples, generating the user signatures for respective users may be based upon applying a trained user signature machine learning model 216 to the user data.

In some examples, the user signature machine learning model 216 may be executed on the computing system 202, while in other examples the user signature machine learning model 216 may be executed on another computing system, separate from the computing system 202. For instance, the computing system 202 may send user data to another computing system, where the trained user signature machine learning model 216 is applied to the user data, and the other computing system may generate a user signature (and/or determine whether user data matches an existing user signature), based upon applying the trained user signature machine learning model 216 to the user data, to the computing system 202. Moreover, in some examples, the user signature machine learning model 216 may be trained by a machine learning model training application 214 executing on the computing system 202, while in other examples, the user signature machine learning model 216 may be trained by a machine learning model training application executing on another computing system, separate from the computing system 202.

Whether the user signature machine learning model 216 is trained on the computing system 202 or elsewhere, the user signature machine learning model 216 may be trained by the machine learning model training application using training data corresponding to historical user data. The trained user signature machine learning model 216 may then be applied to user data in order to generate a user signature (and/or determine whether user data matches an existing user signature).

In various aspects, the user signature machine learning model 216 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. The user signature machine learning model 216 may be or may include a multimodal (e.g., text, audio, video, image, etc.) language model, and may be a small language model, a large language model, and/or a hybrid language model in various embodiments for purposes of model efficiency and/or specificity.

In some embodiments, the artificial intelligence and/or machine learning based algorithms used to train the user signature machine learning model 216 may comprise a library or package executed on the computing system 202 (or other computing devices not shown in FIG. 2). For example, such libraries may include the TENSORFLOW based library, the PYTORCH library, and/or the SCIKIT-LEARN Python library.

Machine learning may involve identifying and recognizing patterns in existing data (such as training a model based upon historical user data) in order to facilitate making predictions or identification for subsequent data (such as using the user signature machine learning model 216 on new user data order to determine a likelihood that the new user data matches an existing user signature).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

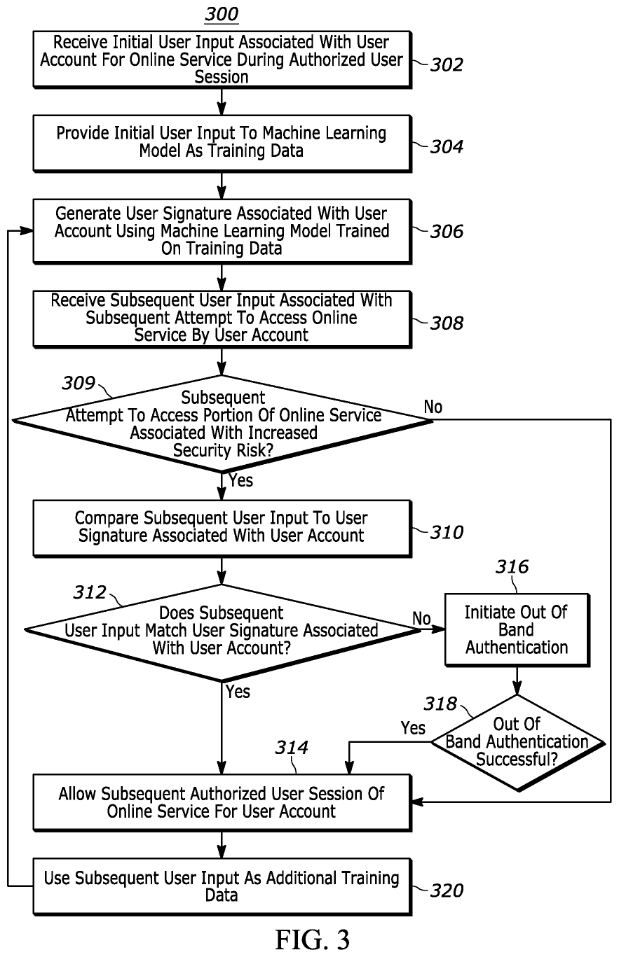

In addition, memories 210 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 210 may include instructions for carrying out any of the steps discussed with respect to the schematic diagram 100 shown at FIG. 1, and/or any of the steps of the method 300 (which is described in greater detail below with respect to FIG. 3) via algorithms stored on the memories 210 and executing on the processors 208. It should be appreciated that one or more other applications may be envisioned and that are executed by the processor(s) 208. It should be appreciated that given the state of advancements of mobile computing devices, all of the processes functions and steps described herein may be present together on a mobile computing device, such as one of the user computing devices 204A, 204B, 204C.

### Example Method

FIG. 3 depicts a flow diagram of an exemplary computer-implemented method 300 for adaptive intelligent user validation, according to one embodiment. One or more steps of the method 300 may be implemented as a set of instructions stored on a computer-readable memory (e.g., memory 210) and executable on one or more processors (e.g., processor 208).

The method 300 may include receiving (block 302) an indication of initial user input associated with a user account for an online service during an authorized user session. For instance, the initial user input may include one or more initial user-submitted responses to respective initial security questions during the authorized user session. For example, these questions and responses may be biographical (e.g., the user's birthday, social security number, hometown, etc.), may be responses with respect to historical events in the user's life (e.g., “Who was your first grade teacher?”, “What was the make and model of your first car?”) or may be responses with respect to user preferences (e.g., “What is your favorite pizza topping?”, “What is your favorite band?”).

Additionally or alternatively, in some examples, the initial user input may include one or more user cursor actions, user keystroke actions, and/or user accelerometer actions, during the authorized user session. Furthermore, in some examples, the initial user input may include an order of the one or more user cursor actions, user keystroke actions, and/or user accelerometer actions, and/or a time duration of one or more of (or each of) the one or more user cursor actions, user keystroke actions, and/or user accelerometer actions. That is, the initial user input may include the ways in which (and/or the speed with which) the user types, moves their cursor, navigates a website or application, or otherwise moves their device as they interact with the website or application.

The method 300 may include providing (block 304) the initial user input associated with the user account for the online service during the authorized user session to a machine learning model as training data. For instance, the machine learning model may be or may include a multimodal (e.g., text, audio, video, image, etc.) language model, and may be a small language model, a large language model, and/or a hybrid language model in various embodiments for purposes of model efficiency and/or specificity.

The method 300 may include generating (block 306), one or more user signatures (e.g., respective user signatures for each channel—mobile device, telephone, laptop, desktop, etc.) associated with the user account based on providing the initial user input associated with the user account for the online service during the authorized user session to the machine learning model as training data. For example, in embodiments in which the initial user input includes initial user-submitted responses to respective security questions, generating the user signature associated with the user account may include generating new security questions and respective generated answers to the new security questions associated with the user account.

For instance, the new security questions and answers may be based on the initial security questions and answers, but may be worded differently than the initial security questions and answers. For example, an initial security question may be “Who was your first grade teacher?” and the initial user input as the answer to the question may be “Mrs. Smith.” The new security question may be “What grade did Mrs. Smith teach?” and the answer may be “First grade.” As another example, some initial security questions may include “What was your hometown?” and “What is your date of birth?”, and the new security questions may be questions that other individuals in the same age and/or demographic group who had the same hometown are predicted to know, such as questions about major events that occurred in the area during the individuals' lifetimes, questions about sports teams in the area, etc. The new security questions may also include a predicted amount of time in which the user will accurately answer the question, and/or a predicted way that the user will interact with the application or web browser as they answer the question, e.g., indicative of a user who knows the question instantly compared to user who needs to look up an answer.

Additionally or alternatively, for example, in embodiments in which the initial user input includes initial user cursor actions, user keystroke actions, user accelerometer actions, etc., from authorized user sessions, generating the user signature associated with the user account may include generating one or more predicted user cursor actions, predicted user keystroke actions, and/or predicted user accelerometer actions for respective user interfaces. For instance, the prediction may include a predicted order and/or a predicted time duration for one or more of (or each of) the one or more predicted user cursor actions, predicted user keystroke actions, and/or predicted user accelerometer actions.

The method 300 may include receiving (block 308) subsequent input associated with a subsequent attempt to access the online service by the user account. For instance, in some examples, the subsequent input may include a subsequent answer to a new security question generated in association with the user account, submitted as user input during a subsequent attempt to access the online service by the user account. Additionally or alternatively, in some examples, the subsequent input associated with the subsequent attempt to access the online service by the user account includes subsequent user cursor actions, subsequent user keystroke actions, and/or subsequent user accelerometer actions associated with the subsequent attempt to access the online service.

In some examples, the method 300 may include block 309, at which a determination may be made as to whether the user's subsequent attempt to access the online service is an attempt to access a portion of the online service associated with an increased risk. If not (block 309, NO), the method may bypass blocks 310, 312, and 316, and may proceed to block 314, discussed in greater detail below.

If so (block 309, YES), the method 300 may include comparing (block 310) the subsequent input associated with the subsequent attempt to access the online service by the user account to the user signature associated with the user account. For example, comparing the subsequent input to the user signature may include the comparing the generated answer to a new security question to a subsequent answer to the new security question submitted as user input. Additionally or alternatively, in some examples, comparing the subsequent input to the user signature may include comparing the predicted user cursor actions, predicted user keystroke actions, and/or predicted user accelerometer actions for a user interface associated with the subsequent attempt to access the online service to the subsequent user cursor actions, subsequent user keystroke actions, and/or subsequent user accelerometer actions associated with the subsequent attempt to access the online service.

At block 312, a determination may be made as to whether the subsequent input matches the user signature associated with the user account. If so (block 312, YES), the method 300 may include allowing (block 314) a subsequent authorized user session of the online service for the user account. In some examples, the subsequent user input may used (block 320) as additional training data for the machine learning model that generates the user signatures at block 316.

If not (block 312, NO), the method 300 may include initiating an out of band authentication. For instance, upon receiving a successful out of band authentication (block 318, YES), a subsequent authorized user session of the online service for the user account may be allowed (block 314), and upon receiving an unsuccessful out of band authentication, a subsequent authorized user session of the online service for the user account may be prevented. Furthermore, in some examples, the method 300 may include providing (block 320) the subsequent user input associated with the subsequent attempt to access the online service to the machine learning model as additional training data, in the case of the successful out of band authentication (but not in the case of the unsuccessful out of band authentication).

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for adaptive intelligent user validation. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Aspects

1. A computer-implemented method for adaptive intelligent user validation, comprising: receiving, by one or more processors, an indication of initial user input associated with a user account for an online service during an authorized user session; providing, by the one or more processors, the initial user input associated with the user account for the online service during the authorized user session to a machine learning model as training data; generating, by the one or more processors, based on providing the initial user input associated with the user account for the online service during the authorized user session to the machine learning model as training data, a user signature associated with the user account; receiving, by the one or more processors, subsequent input associated with a subsequent attempt to access the online service by the user account; comparing, by the one or more processors, the subsequent input associated with the subsequent attempt to access the online service by the user account to the user signature associated with the user account; and allowing, by the one or more processors, a subsequent authorized user session of the online service for the user account based on determining that the subsequent input associated with the subsequent attempt to access the online service by the user account matches the user signature associated with the user account.

2. The method of aspect 1, further comprising: wherein the initial user input associated with the user account for the online service during the authorized user session includes one or more initial user-submitted responses to respective initial security questions, wherein generating the user signature associated with the user account includes generating new security questions and respective generated answers to the new security questions associated with the user account, wherein the subsequent input associated with the subsequent attempt to access the online service by the user account includes subsequent answers to the new security questions associated with the user account; and wherein comparing the subsequent input associated with the subsequent attempt to access the online service by the user account to the user signature associated with the user account includes comparing the subsequent answers to the new security questions associated with the user account to the generated answers to the new security questions associated with the user account.

3. The computer-implemented method of any one of aspects 1 or 2, wherein the initial user input associated with the user account for the online service during the authorized user session includes at least one of a user cursor action, a user keystroke action, or a user accelerometer action, during the authorized user session; wherein generating the user signature associated with the user account includes generating at least one of a predicted user cursor action, a predicted user keystroke action, or a predicted user accelerometer action for respective user interfaces; wherein the subsequent input associated with the subsequent attempt to access the online service by the user account includes at least one subsequent user cursor action, subsequent user keystroke action, or subsequent user accelerometer action associated with the subsequent attempt to access the online service; wherein comparing the subsequent input associated with the subsequent attempt to access the online service by the user account to the user signature associated with the user account includes comparing the at least one predicted user cursor action, predicted user keystroke action, or predicted user accelerometer action for a user interface associated with the subsequent attempt to access the online service to the at least one subsequent user cursor action, subsequent user keystroke action, or subsequent user accelerometer action associated with the subsequent attempt to access the online service.

4. The computer-implemented method of aspect 3, wherein the at least one of the user cursor action, the user keystroke action, or the user accelerometer action include time durations or time series associated with the respective user cursor action, user keystroke action, or user accelerometer action, and wherein the predicted user cursor actions, predicted user keystroke actions, or predicted user accelerometer actions for respective user interfaces include predicted time durations or time series associated with predicted user cursor actions, predicted user keystroke actions, or predicted user accelerometer actions.

5. The computer-implemented method of any one of aspects 3 or 4, wherein the at least one of the user cursor action, the user keystroke action, or the user accelerometer action include an order associated with respective user cursor or keystroke actions, and wherein the predicted cursor or keystroke actions for respective user interfaces include a predicted order associated with the predicted user cursor actions, predicted user keystroke actions, or predicted user accelerometer actions for respective user interfaces.

6. The computer-implemented method of any one of aspects 1-5, wherein the subsequent attempt to access the online service is an attempt to access a portion of the online service associated with an increased security risk.

7. The computer-implemented method of aspect 6, further comprising allowing a subsequent unauthorized user session of the online service for a portion of the online service associated with a decreased security risk without requiring a comparison to the user signature associated with the user account.

8. The computer-implemented method of any one of aspects 1-7, wherein the machine learning model is a multimodal language model, and is one or more of a small language model, a large language model, or a hybrid language model.

9. The computer-implemented method of any one of aspects 1-8, further comprising, providing, by the one or more processors, the subsequent user input associated with the subsequent attempt to access the online service to the machine learning model as additional training data, based on determining that the subsequent input associated with the subsequent attempt to access the online service by the user account matches the user signature associated with the user account.

10. A computer-implemented method for adaptive intelligent user validation, comprising: receiving, by one or more processors, an indication of initial user input associated with a user account for an online service during an authorized user session; providing, by the one or more processors, the initial user input associated with the user account for the online service during the authorized user session to a machine learning model as training data; generating, by the one or more processors, based on providing the initial user input associated with the user account for the online service during the authorized user session to the machine learning model as training data, a user signature associated with the user account; receiving, by the one or more processors, subsequent input associated with a subsequent attempt to access the online service by the user account; comparing, by the one or more processors, the subsequent input associated with the subsequent attempt to access the online service by the user account to the user signature associated with the user account; and initiating, by the one or more processors, an out of band authentication based on determining that the subsequent input associated with the subsequent attempt to access the online service by the user account does not match the user signature associated with the user account.

11. The computer-implemented method of aspect 10, further comprising: receiving, by the one or more processors, a successful out of band authentication; and allowing, by the one or more processors, a subsequent authorized user session of the online service for the user account based on the successful out of band authentication.

12. The computer-implemented method of aspect 11, further comprising: providing, by the one or more processors, the subsequent user input associated with the subsequent attempt to access the online service to the machine learning model as additional training data, based on the successful out of band authentication.

13. The computer-implemented method of aspect 10, further comprising: receiving, by the one or more processors, an unsuccessful out of band authentication; and preventing, by the one or more processors, a subsequent authorized user session of the online service for the user account based on the unsuccessful out of band authentication.

14. A computer system comprising one or more processors, and one or more non-transitory memories storing computer-readable instructions for adaptive intelligent user validation that, when executed by one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and allow a subsequent authorized user session of the online service for the user account based on determining that the subsequent input associated with the subsequent attempt to access the online service by the user account matches the user signature associated with the user account.

15. The computer system of aspect 14, wherein the initial user input associated with the user account for the online service during the authorized user session includes one or more initial user-submitted responses to respective initial security questions, wherein the instructions, when executed by the one or more processors, cause the one or more processors to generate the user signature associated with the user account by generating new security questions and respective generated answers to the new security questions associated with the user account, wherein the subsequent input associated with the subsequent attempt to access the online service by the user account includes subsequent answers to the new security questions associated with the user account, and wherein the instructions, when executed by the one or more processors, cause the one or more processors to compare the subsequent input associated with the subsequent attempt to access the online service by the user account to the user signature associated with the user account by comparing the subsequent answers to the new security questions associated with the user account to the generated answers to the new security questions associated with the user account.

16. The computer system of any one of aspects 14 or 15, wherein the initial user input associated with the user account for the online service during the authorized user session includes at least one of a user cursor action, a user keystroke action, or a user accelerometer action, during the authorized user session; wherein the instructions, when executed by the one or more processors, cause the one or more processors to generate the user signature associated with the user account by generating at least one of a predicted user cursor action, a predicted user keystroke action, or a predicted user accelerometer action for respective user interfaces; wherein the subsequent input associated with the subsequent attempt to access the online service by the user account includes at least one subsequent user cursor action, subsequent user keystroke action, or subsequent user accelerometer action associated with the subsequent attempt to access the online service; wherein the instructions, when executed by the one or more processors, cause the one or more processors to compare the subsequent input associated with the subsequent attempt to access the online service by the user account to the user signature associated with the user account by comparing the at least one predicted user cursor action, predicted user keystroke action, or predicted user accelerometer action for a user interface associated with the subsequent attempt to access the online service to the at least one subsequent user cursor action, subsequent user keystroke action, or subsequent user accelerometer action associated with the subsequent attempt to access the online service.

17. The computer system of aspect 16, wherein the at least one of the user cursor action, the user keystroke action, or the user accelerometer action include time durations or time series associated with the respective user cursor action, user keystroke action, or user accelerometer action, and wherein the predicted user cursor actions, predicted user keystroke actions, or predicted user accelerometer actions for respective user interfaces include predicted time durations or time series associated with predicted user cursor actions, predicted user keystroke actions, or predicted user accelerometer actions.

18. The computer system of any one of aspects 16 or 17, wherein the at least one of the user cursor action, the user keystroke action, or the user accelerometer action include an order associated with respective user cursor or keystroke actions, and wherein the predicted cursor or keystroke actions for respective user interfaces include a predicted order associated with the predicted user cursor actions, predicted user keystroke actions, or predicted user accelerometer actions for respective user interfaces.

19. The computer system of any one of aspects 14-18, wherein the subsequent attempt to access the online service is an attempt to access a portion of the online service associated with an increased security risk.

20. The computer system of any one of aspects 14-19, wherein the instructions, when executed by the one or more processors, further cause the one or more processors to allow a subsequent unauthorized user session of the online service for a portion of the online service associated with a decreased security risk without requiring a comparison to the user signature associated with the user account.

21. The computer system of any one of aspects 14-20, wherein the machine learning model is a multimodal language model, and is one or more of a small language model, a large language model, or a hybrid language model.

22. The computer system of any one of aspects 14-21, wherein the instructions, when executed by the one or more processors, further cause the one or more processors to: provide the subsequent user input associated with the subsequent attempt to access the online service to the machine learning model as additional training data, based on determining that the subsequent input associated with the subsequent attempt to access the online service by the user account matches the user signature associated with the user account.

23. A computer system comprising one or more processors, and one or more non-transitory memories storing computer-readable instructions for adaptive intelligent user validation that, when executed by one or more processors, cause the one or more processors to at least: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and initiate an out of band authentication based on determining that the subsequent input associated with the subsequent attempt to access the online service by the user account does not match the user signature associated with the user account.

24. The computer system of aspect 23, wherein the instructions, when executed by the one or more processors, further cause the one or more processors to: receive a successful out of band authentication; and allow a subsequent authorized user session of the online service for the user account based on the successful out of band authentication.

25. The computer system of aspect 24, wherein the instructions, when executed by the one or more processors, further cause the one or more processors to: provide the subsequent user input associated with the subsequent attempt to access the online service to the machine learning model as additional training data, based on the successful out of band authentication.

26. The computer system of aspect 23, wherein the instructions, when executed by the one or more processors, further cause the one or more processors to: receive an unsuccessful out of band authentication; and prevent a subsequent authorized user session of the online service for the user account based on the unsuccessful out of band authentication.

27. A non-transitory computer-readable medium storing instructions for adaptive intelligent user validation that, when executed by one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and allow a subsequent authorized user session of the online service for the user account based on determining that the subsequent input associated with the subsequent attempt to access the online service by the user account matches the user signature associated with the user account.

28. The non-transitory computer-readable medium of aspect 27, wherein the initial user input associated with the user account for the online service during the authorized user session includes one or more initial user-submitted responses to respective initial security questions, wherein the instructions, when executed by the one or more processors, cause the one or more processors to generate the user signature associated with the user account by generating new security questions and respective generated answers to the new security questions associated with the user account, wherein the subsequent input associated with the subsequent attempt to access the online service by the user account includes subsequent answers to the new security questions associated with the user account, and wherein the instructions, when executed by the one or more processors, cause the one or more processors to compare the subsequent input associated with the subsequent attempt to access the online service by the user account to the user signature associated with the user account by comparing the subsequent answers to the new security questions associated with the user account to the generated answers to the new security questions associated with the user account.

29. The non-transitory computer-readable medium of any one of aspects 27 or 28, wherein the initial user input associated with the user account for the online service during the authorized user session includes at least one of a user cursor action, a user keystroke action, or a user accelerometer action, during the authorized user session; wherein the instructions, when executed by the one or more processors, cause the one or more processors to generate the user signature associated with the user account by generating at least one of a predicted user cursor action, a predicted user keystroke action, or a predicted user accelerometer action for respective user interfaces; wherein the subsequent input associated with the subsequent attempt to access the online service by the user account includes at least one subsequent user cursor action, subsequent user keystroke action, or subsequent user accelerometer action associated with the subsequent attempt to access the online service; wherein the instructions, when executed by the one or more processors, cause the one or more processors to compare the subsequent input associated with the subsequent attempt to access the online service by the user account to the user signature associated with the user account by comparing the at least one predicted user cursor action, predicted user keystroke action, or predicted user accelerometer action for a user interface associated with the subsequent attempt to access the online service to the at least one subsequent user cursor action, subsequent user keystroke action, or subsequent user accelerometer action associated with the subsequent attempt to access the online service.

30. The non-transitory computer-readable medium of aspect 29, wherein the at least one of the user cursor action, the user keystroke action, or the user accelerometer action include time durations or time series associated with the respective user cursor action, user keystroke action, or user accelerometer action, and wherein the predicted user cursor actions, predicted user keystroke actions, or predicted user accelerometer actions for respective user interfaces include predicted time durations or time series associated with predicted user cursor actions, predicted user keystroke actions, or predicted user accelerometer actions.

31. The non-transitory computer-readable medium of any one of aspects 29 or 30, wherein the at least one of the user cursor action, the user keystroke action, or the user accelerometer action include an order associated with respective user cursor or keystroke actions, and wherein the predicted cursor or keystroke actions for respective user interfaces include a predicted order associated with the predicted user cursor actions, predicted user keystroke actions, or predicted user accelerometer actions for respective user interfaces.

32. The non-transitory computer-readable medium of any one of aspects 27-31, wherein the subsequent attempt to access the online service is an attempt to access a portion of the online service associated with an increased security risk.

33. The non-transitory computer-readable medium of any one of aspects 27-32, wherein the instructions, when executed by the one or more processors, further cause the one or more processors to allow a subsequent unauthorized user session of the online service for a portion of the online service associated with a decreased security risk without requiring a comparison to the user signature associated with the user account.

34. The non-transitory computer-readable medium of any one of aspects 27-33, wherein the machine learning model is a multimodal language model, and is one or more of a small language model, a large language model, or a hybrid language model.

35. The non-transitory computer-readable medium of any one of aspects 27-34, wherein the instructions, when executed by the one or more processors, further cause the one or more processors to: provide the subsequent user input associated with the subsequent attempt to access the online service to the machine learning model as additional training data, based on determining that the subsequent input associated with the subsequent attempt to access the online service by the user account matches the user signature associated with the user account.

36. A non-transitory computer-readable medium storing instructions for adaptive intelligent user validation that, when executed by one or more processors, cause the one or more processors to: receive an indication of initial user input associated with a user account for an online service during an authorized user session; provide the initial user input associated with the user account for the online service during the authorized user session to a machine learning model as training data; generate, based on providing the initial user input associated with the user account for the online service during the authorized user session to the machine learning model as training data, a user signature associated with the user account; receive subsequent input associated with a subsequent attempt to access the online service by the user account; compare the subsequent input associated with the subsequent attempt to access the online service by the user account to the user signature associated with the user account; and initiate an out of band authentication based on determining that the subsequent input associated with the subsequent attempt to access the online service by the user account does not match the user signature associated with the user account.

37. The non-transitory computer-readable medium of aspect 36, wherein the instructions, when executed by the one or more processors, further cause the one or more processors to: receive a successful out of band authentication; and allow a subsequent authorized user session of the online service for the user account based on the successful out of band authentication.

38. The non-transitory computer-readable medium of aspect 37, wherein the instructions, when executed by the one or more processors, further cause the one or more processors to: provide the subsequent user input associated with the subsequent attempt to access the online service to the machine learning model as additional training data, based on the successful out of band authentication.

39. The non-transitory computer-readable medium of aspect 36, wherein the instructions, when executed by the one or more processors, further cause the one or more processors to: receive an unsuccessful out of band authentication; and prevent a subsequent authorized user session of the online service for the user account based on the unsuccessful out of band authentication.

What is claimed is:

1. A computer-implemented method for adaptive intelligent user validation, comprising:
receiving, by one or more processors, an indication of initial user input associated with a user account for an online service during an authorized user session;
providing, by the one or more processors, the initial user input associated with the user account for the online service during the authorized user session to a machine learning model as training data;
generating, by the one or more processors, based on providing the initial user input associated with the user account for the online service during the authorized user session to the machine learning model as training data, a user signature associated with the user account;
receiving, by the one or more processors, subsequent input associated with a subsequent attempt to access the online service by the user account;
comparing, by the one or more processors, the subsequent input associated with the subsequent attempt to access the online service by the user account to the user signature associated with the user account; and
allowing, by the one or more processors, a subsequent authorized user session of the online service for the user account based on determining that the subsequent input associated with the subsequent attempt to access the online service by the user account matches the user signature associated with the user account.

2. The method of claim 1, further comprising:
wherein the initial user input associated with the user account for the online service during the authorized user session includes one or more initial user-submitted responses to respective initial security questions,
wherein generating the user signature associated with the user account includes generating new security questions and respective generated answers to the new security questions associated with the user account,
wherein the subsequent input associated with the subsequent attempt to access the online service by the user account includes subsequent answers to the new security questions associated with the user account; and
wherein comparing the subsequent input associated with the subsequent attempt to access the online service by the user account to the user signature associated with the user account includes comparing the subsequent answers to the new security questions associated with the user account to the generated answers to the new security questions associated with the user account.

3. The computer-implemented method of claim 1,
wherein the initial user input associated with the user account for the online service during the authorized user session includes at least one of a user cursor action, a user keystroke action, or a user accelerometer action, during the authorized user session;
wherein generating the user signature associated with the user account includes generating at least one of a predicted user cursor action, a predicted user keystroke action, or a predicted user accelerometer action for respective user interfaces;
wherein the subsequent input associated with the subsequent attempt to access the online service by the user account includes at least one subsequent user cursor action, subsequent user keystroke action, or subsequent user accelerometer action associated with the subsequent attempt to access the online service;
wherein comparing the subsequent input associated with the subsequent attempt to access the online service by the user account to the user signature associated with the user account includes comparing the at least one predicted user cursor action, predicted user keystroke action, or predicted user accelerometer action for a user interface associated with the subsequent attempt to access the online service to the at least one subsequent user cursor action, subsequent user keystroke action, or subsequent user accelerometer action associated with the subsequent attempt to access the online service.

4. The computer-implemented method of claim 3, wherein the at least one of the user cursor action, the user keystroke action, or the user accelerometer action include time durations or time series associated with the respective user cursor action, user keystroke action, or user accelerometer action, and wherein the predicted user cursor actions, predicted user keystroke actions, or predicted user accelerometer actions for respective user interfaces include predicted time durations or time series associated with predicted user cursor actions, predicted user keystroke actions, or predicted user accelerometer actions.

5. The computer-implemented method of claim 3, wherein the at least one of the user cursor action, the user keystroke action, or the user accelerometer action include an order associated with respective user cursor or keystroke actions, and wherein the predicted cursor or keystroke actions for respective user interfaces include a predicted order associated with the predicted user cursor actions, predicted user keystroke actions, or predicted user accelerometer actions for respective user interfaces.

6. The computer-implemented method of claim 1, wherein the subsequent attempt to access the online service is an attempt to access a portion of the online service associated with an increased security risk.

7. The computer-implemented method of claim 6, further comprising allowing a subsequent unauthorized user session of the online service for a portion of the online service associated with a decreased security risk without requiring a comparison to the user signature associated with the user account.

8. The computer-implemented method of claim 1, wherein the machine learning model is a multimodal language model, and is one or more of a small language model, a large language model, or a hybrid language model.

9. The computer-implemented method of claim 1, further comprising,
providing, by the one or more processors, the subsequent user input associated with the subsequent attempt to access the online service to the machine learning model as additional training data, based on determining that the subsequent input associated with the subsequent attempt to access the online service by the user account matches the user signature associated with the user account.

10. A computer-implemented method for adaptive intelligent user validation, comprising:
receiving, by one or more processors, an indication of initial user input associated with a user account for an online service during an authorized user session;
providing, by the one or more processors, the initial user input associated with the user account for the online service during the authorized user session to a machine learning model as training data;
generating, by the one or more processors, based on providing the initial user input associated with the user account for the online service during the authorized user session to the machine learning model as training data, a user signature associated with the user account;
receiving, by the one or more processors, subsequent input associated with a subsequent attempt to access the online service by the user account;
comparing, by the one or more processors, the subsequent input associated with the subsequent attempt to access the online service by the user account to the user signature associated with the user account; and
initiating, by the one or more processors, an out of band authentication based on determining that the subsequent input associated with the subsequent attempt to access the online service by the user account does not match the user signature associated with the user account.

11. The computer-implemented method of claim 10, further comprising:
receiving, by the one or more processors, a successful out of band authentication; and
allowing, by the one or more processors, a subsequent authorized user session of the online service for the user account based on the successful out of band authentication.

12. The computer-implemented method of claim 11, further comprising:
providing, by the one or more processors, the subsequent user input associated with the subsequent attempt to access the online service to the machine learning model as additional training data, based on the successful out of band authentication.

13. The computer-implemented method of claim 10, further comprising:
receiving, by the one or more processors, an unsuccessful out of band authentication; and
preventing, by the one or more processors, a subsequent authorized user session of the online service for the user account based on the unsuccessful out of band authentication.

14. A computer system comprising one or more processors, and one or more non-transitory memories storing computer-readable instructions for adaptive intelligent user validation that, when executed by one or more processors, cause the one or more processors to:
receive an indication of initial user input associated with a user account for an online service during an authorized user session;
provide the initial user input associated with the user account for the online service during the authorized user session to a machine learning model as training data;
generate, based on providing the initial user input associated with the user account for the online service during the authorized user session to the machine learning model as training data, a user signature associated with the user account;
receive subsequent input associated with a subsequent attempt to access the online service by the user account;
compare the subsequent input associated with the subsequent attempt to access the online service by the user account to the user signature associated with the user account; and
allow a subsequent authorized user session of the online service for the user account based on determining that the subsequent input associated with the subsequent attempt to access the online service by the user account matches the user signature associated with the user account.

15. The computer system of claim 14, wherein the initial user input associated with the user account for the online service during the authorized user session includes one or more initial user-submitted responses to respective initial security questions,
wherein the instructions, when executed by the one or more processors, cause the one or more processors to generate the user signature associated with the user account by generating new security questions and respective generated answers to the new security questions associated with the user account,
wherein the subsequent input associated with the subsequent attempt to access the online service by the user account includes subsequent answers to the new security questions associated with the user account, and
wherein the instructions, when executed by the one or more processors, cause the one or more processors to compare the subsequent input associated with the subsequent attempt to access the online service by the user account to the user signature associated with the user account by comparing the subsequent answers to the new security questions associated with the user account to the generated answers to the new security questions associated with the user account.

16. The computer system of claim 14, wherein the initial user input associated with the user account for the online service during the authorized user session includes at least one of a user cursor action, a user keystroke action, or a user accelerometer action, during the authorized user session;
wherein the instructions, when executed by the one or more processors, cause the one or more processors to generate the user signature associated with the user account by generating at least one of a predicted user cursor action, a predicted user keystroke action, or a predicted user accelerometer action for respective user interfaces;
wherein the subsequent input associated with the subsequent attempt to access the online service by the user account includes at least one subsequent user cursor action, subsequent user keystroke action, or subsequent user accelerometer action associated with the subsequent attempt to access the online service;
wherein the instructions, when executed by the one or more processors, cause the one or more processors to compare the subsequent input associated with the subsequent attempt to access the online service by the user account to the user signature associated with the user account by comparing the at least one predicted user cursor action, predicted user keystroke action, or predicted user accelerometer action for a user interface associated with the subsequent attempt to access the online service to the at least one subsequent user cursor action, subsequent user keystroke action, or subsequent user accelerometer action associated with the subsequent attempt to access the online service.

17. The computer system of claim 16, wherein the at least one of the user cursor action, the user keystroke action, or the user accelerometer action include time durations or time series associated with the respective user cursor action, user keystroke action, or user accelerometer action, and wherein the predicted user cursor actions, predicted user keystroke actions, or predicted user accelerometer actions for respective user interfaces include predicted time durations or time series associated with predicted user cursor actions, predicted user keystroke actions, or predicted user accelerometer actions.

18. The computer system of claim 16, wherein the at least one of the user cursor action, the user keystroke action, or the user accelerometer action include an order associated with respective user cursor or keystroke actions, and wherein the predicted cursor or keystroke actions for respective user interfaces include a predicted order associated with the predicted user cursor actions, predicted user keystroke actions, or predicted user accelerometer actions for respective user interfaces.

19. The computer system of claim 14, wherein the subsequent attempt to access the online service is an attempt to access a portion of the online service associated with an increased security risk.

20. The computer system of claim 14, wherein the instructions, when executed by the one or more processors, further cause the one or more processors to allow a subsequent unauthorized user session of the online service for a portion of the online service associated with a decreased security risk without requiring a comparison to the user signature associated with the user account.
